(19) United States
(12) Patent Application Publication
(10) Pub. No.: US 2020/0027626 A1
(43) Pub. Date: Jan. 23, 2020

(54) ELECTRIC CONDUCTOR

(71) Applicant: Martin Koehne, Asperg (DE)

(72) Inventor: Martin Koehne, Asperg (DE)

(21) Appl. No.: 16/499,459

(22) PCT Filed: Mar. 15, 2018
(86) PCT No.: PCT/EP2018/056580

§ 371 Date: Sep. 30, 2019

(30) Foreign Application Priority Data
Mar. 29, 2017 (DE) 10 2017 205 296.1

(51) Int. Cl. H01B 3/02; H01B 1/04; H01B 7/02; H01B 7/04; C01B 32/194; D06M 10/06; D06M 11/09

(52) U.S. Cl. CPC H01B 3/02; H01B 1/04; H01B 7/0216; H01B 13/06; C01B 32/194; D06M 10/06; D06M 11/09; H01B 7/04

(57) ABSTRACT

Yarns for electrical conduction that comprise a composite of fibres composed of carbon nanotubes and/or of a multiplicity of graphene layers and have a specific porosity are already known. The yarns have an electrical insulation layer, which is produced by application of a polymer coating. The electrical insulation layer has to adhere to the yarn sufficiently well for the insulation not to detach even in the event of mechanical stress, for example deflection with a small bending radius. Furthermore, the electrical insulation layer should be as thin as possible in order to achieve a low thermal resistance. Additionally, the electrical insulation layer has to be elastic enough to be able to cope with any geometric changes in the non-rigid yarn without detaching. In the electric conductor according to the invention, the electrical insulation is improved. The invention provides for the outer fibres of the composite to be fluorinated in such a way that they form an electrical insulation layer (2) and for the fibres in an internal region (3) to be electrically conductive.

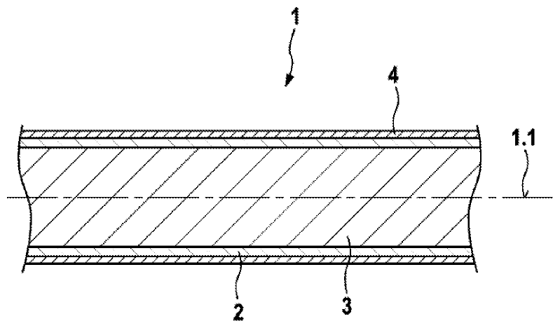

### BACKGROUND OF THE INVENTION

The starting point for the invention is an electric conductor, more particularly a yarn.

A yarn for electrical conduction is already known from WO2012/106406 A1, said yarn comprising an assembly of fibers composed of carbon nanotubes and/or of a multiplicity of layers of graphene, and having a defined porosity. The yarn has an electrical insulation layer produced by application of a polymer coating. The adhesion of the electrical insulation layer to the yarn must be of a quality such that the insulation does not detach even on mechanical stress, as for example on deflection with a small bending radius. The electrical insulation layer, moreover, is to be extremely thin, so as to achieve low resistance to thermal conduction. The electrical insulation layer, furthermore, must be sufficiently elastic to be able to conform to the possible geometric changes of the flexurally slack yarn without detaching.

### SUMMARY OF THE INVENTION

Relative to the prior art, the electric conductor of the invention has the advantage that the electrical insulation of the electric conductor is improved by virtue of the outer fibers of the assembly of fibers being fluorinated in such a way that they form an electrical insulation layer and such that the fibers in an inside region are electrically conducting. In this way the outer fibers of the assembly themselves form an electrical insulation. This insulation of the invention is very flexible and can be applied even to very small bending radii without any risk of the electrical insulation being parted or torn off.

It is particularly advantageous that the degree of fluorination of the fibers, starting from the outer fibers forming the insulation layer, decreases with increasing distance from an outside periphery of the electric conductor, since in this way the inner core of the electric conductor is electrically conductive.

According to one advantageous exemplary embodiment, the insulation layer formed by the outer fibers has a thickness of at least 100 nm and not more than 100 μm.

It is further advantageous if the porosity of the assembly of fibers is implemented such that the outer fibers are electrically nonconducting, as a result of the interaction with fluorine, and the fibers lying in the inside region are electrically conducting, as a result of little or no contact with the fluorine. In this way, electrical insulation of the electric conductor can be achieved solely by fluorination of the electric conductor and without application of an additional coating.

According to one advantageous exemplary embodiment, the porosity of the electric conductor is less than 10%, more particularly less than 7%.

It is also advantageous if provision is made for an additional polymer coating of the electric conductor. In this way the insulation layer of the electric conductor, formed by fluorination, is reinforced. It also enables the polymer coating to adhere particularly well to the fluorinated outer fibers of the electric conductor.

The insulation layer of the electric conductor, formed by fluorination, may be achieved advantageously by treatment of the electric conductor with a fluorine-containing gas or plasma.

### BRIEF DESCRIPTION OF THE DRAWING

The single drawing FIGURE shows an exemplary embodiment of the invention in simplified form.

### DETAILED DESCRIPTION

The electric conductor 1 of the invention is formed of an assembly of fibers, with the fibers comprising carbon nanotubes (CNT nanotubes) and/or a multiplicity of layers of graphene, and being produced more particularly from carbon nanotubes (CNT nanotubes) and/or from a multiplicity of layers of graphene. Between the fibers of the assembly there are cavities formed, and so there is a defined porosity. The electric conductor 1 comprises a multiplicity of fibers which run in the direction of a longitudinal extent 1.1 of the electric conductor 1 and which are held together in a known way, as for example by twisting, braiding or knotting. The electric conductor 1 is for example a yarn.

Provision is made in accordance with the invention for the outer fibers of the assembly to be fluorinated in such a way that they form an electrical insulation layer 2 and that the fibers in an inside region 3 are electrically conducting. The insulation layer 2 may be a closed layer or a layer which is open with respect to the inside region 3.

The outer fibers which form the electrical insulation layer 2 are located on the outside periphery of the electric conductor 1 and in a defined region below it. These outer fibers are electrically nonconducting, owing to treatment with fluorine. The insulation layer 2 may for example have a thickness of at least 100 nm and not more than 100 μm.

The fibers beneath the insulation layer 2 form the inside region 3, in which the fibers are electrically conducting. The degree of fluorination, this being the ratio of carbon atoms to fluorine atoms, of the fibers of the electric conductor 1, starting from the outer fibers forming the insulation layer 2, and going radially inward in relation to the axis 1.1, decreases with increasing distance from the outside periphery of the electric conductor 1, and so the fibers within the insulation layer 2 are electrically conductive. For example, the electrical conductivity of the electric conductor 1 on 90% of the conductor cross-section of the electric conductor 1 after the fluorination is still at least 90% of the original value.

The porosity of the assembly of fibers is implemented in such a way that the outer fibers of the electric conductor 1 are electrically nonconducting, owing to the interaction with fluorine, and the fibers in the inside region 3 are electrically conducting, owing to little or no contact with the fluorine.

According to the exemplary embodiment, the fibers of the electric conductor 1 are treated with a fluorine-containing gas or a fluorine-containing plasma in order to produce the insulation layer 2. For example, the electric conductor may be disposed in a plasma chamber in which there is a subatmospheric pressure and in which argon and a fluorine-containing gas—for example, tetrafluoromethane or fluorine gas—are provided, to allow a plasma generator to generate the plasma in a known way in the plasma chamber.

The porosity of the electric conductor 1 is for example implemented at less than 10%, more particularly less than 7%. Graphite reacts with the fluorine in the temperature range from 200 to 550° C. to give graphite fluoride, as disclosed in DE 3231238 A1. At a degree of fluorination of below 0.9, graphite fluoride conducts the electrical current in the same way as graphite. At a degree of fluorination of 1.0, graphite fluoride is an electrical insulator. Part of the invention is that the fluorination takes place only in the region of the outer fibers, so that the inside region 3 is not fluorinated or is fluorinated only partially or only slightly. This means that in accordance with the invention, the outer fibers are fluorinated almost completely, to form the insulation layer 2. Below this layer is a layer which is only partially fluorinated and whose fluorine content decreases sharply with increasing distance from the surface of the electric conductor 1. In the core 3, both the electrical conductivity and the mechanical strength of the fibers are retained. For this to be ensured, the electric conductor possesses a porosity of not more than 10%, more particularly not more than 7%. If the porosity is greater than this maximum value, the depth of penetration of the fluorination becomes too high.

Various methods of fluorination were considered, such as, for example, mixing with reactive, fluorine-containing solutions, reaction with fluorine-containing gases at elevated temperature, and treatment with fluorine-containing plasma. Of these methods, the plasma treatment represents an advantageous method. Besides the possibility of precisely adjusting the depth of fluorination via the parameters of plasma power, fluorine-containing gases used, pressure, and duration, the plasma treatment also affords the possibility of carrying out fluorination at room temperature and in a short time. Furthermore, a plasma operation also affords the possibility in addition to the fluorination of building up a PTFE-like substance on the surface of the electric conductor 1.

Additionally to the insulation layer 2, the electric conductor 1 may have a polymer coating 4 applied to the insulation layer 2. The polymer coating consists of an elastic polymer, as for example of polyvinyl chloride (PVC), crosslinked polyethylene (XLPE), silicone rubber or nitrile butyl rubber.

The carbon-fluorine bonding on the surface of the fibers is strong enough for said surface to develop strong hydrogen bonds to molecules possessing OH groups. This allows a significant improvement in the adhesion of polymers having OH groups to the surface of the electric conductor 1.

1. An electric conductor which comprises an assembly of fibers and has a defined porosity, the assembly of fibers comprising carbon nanotubes and/or a multiplicity of layers of graphene, and the assembly of fibers comprising outer fibers and inner fibers, characterized in that the outer fibers are fluorinated in such a way that the outer fibers form an electrical insulation layer (2) and wherein the inner fibers are in an inside region (3) and are electrically conducting.

2. The electric conductor as claimed in claim 1, characterized in that a degree of fluorination of the fibers, starting from the outer fibers forming the insulation layer (2), decreases with increasing distance from an outside periphery of the electric conductor (1).

3. The electric conductor as claimed in claim 1, characterized in that the insulation layer (2) formed by the outer fibers has a thickness of at least 100 nm and not more than 100 μm.

4. The electric conductor as claimed in claim 1, characterized in that the porosity of the assembly of fibers is implemented such that the outer fibers are electrically nonconducting, as a result of interaction with fluorine, and the inner fibers lying in the inside region (3) are electrically conducting, as a result of little or no contact with the fluorine.

5. The electric conductor as claimed in claim 4, characterized in that the porosity of the electric conductor (1) is less than 10%.

6. The electric conductor as claimed in claim 4, further comprising an additional polymer coating (4) of the electric conductor (1).

7. A method for producing an electric conductor as claimed in claim 1, characterized in that the electric conductor (1) is treated with a fluorine-containing gas or a fluorine-containing plasma.

8. The method as claimed in claim 7, characterized in that the electrical conductor is a yarn.

9. The electric conductor as claimed in claim 1, characterized in that the electrical conductor is a yarn.

10. The electric conductor as claimed in claim 4, characterized in that the porosity of the electric conductor (1) is less than 7%.

11. The electric conductor as claimed in claim 1, characterized in that the assembly of fibers comprises carbon nanotubes

12. The electric conductor as claimed in claim 11, characterized in that the assembly of fibers comprises a multiplicity of layers of graphene

13. The electric conductor as claimed in claim 1, characterized in that the assembly of fibers comprises a multiplicity of layers of graphene
